(19) United States
(12) Patent Application Publication
(10) Pub. No.: US 2002/0166800 A1
(43) Pub. Date: Nov. 14, 2002

(54) Micromagnetic systems and methods for microfluidics

(76) Inventors: Mara G. Prentiss, Cambridge, MA (US); Gary Zabow, Somerville, MA (US); Tao Deng, Somerville, MA (US); Mala Lakshmi Radhakrishnan, Simsbury, CT (US); George M. Whitesides, Newton, MA (US)

Correspondence Address: Timothy J. Oyer, Wolf, Greenfield & Sacks, P.C., 600 Atlantic Avenue, Boston, MA, 02210, US

(21) Appl. No.: 09/853,888

(22) Filed: May 11, 2001

(51) Int. Cl. B03C 1/00

(52) U.S. Cl. 209/214; 209/232

(57) ABSTRACT

The invention provides systems and methods of manipulating biological or chemical species. The species may be attached to a magnetic particle which is manipulated using micro-magnetic fields. In some cases, the magnetic fields are generated by current carrying wires that are patterned on a substrate. The magnetic fields define channels on the surface of the substrate in which the magnetic particles and attached species may be transported, positioned and stored. Thus, the systems and methods can manipulate biological or chemical species on a microscale (e.g., less than 5 cm). Applications of the systems and methods are in, but are not limited to, the fields of biotechnology, microanalysis, and microsynthesis.

### FIELD OF THE INVENTION

The invention relates generally to micromagnetic systems and methods and, more particularly, to systems and methods which manipulate biological or chemical species using magnetic fields in microfluidic applications.

### BACKGROUND OF THE INVENTION

The ability to manipulate chemical species (e.g., chemical reagents) or biological species (e.g., cellular material, polymers, proteins, DNA, and the like) on a microscale is important in many applications. Such applications are in the fields of biotechnology, microanalysis, and microsynthesis, amongst others. Depending on the application, the manipulations may involve separating, transporting, positioning, and/or storing the species.

Conventionally, microfluidic systems can be used to manipulate chemical or biological species. These systems involve controlling fluid flow on a microscale. Chemical or biological species that are suspended in the fluid may, thus, be manipulated. In some microfluidic systems, pumps and/or valves are used to control fluid flow through a series of physical microchannels formed within a substrate. Such systems generally are not easily fabricated, have a complex structure, and are not easily reconfigured for different operations or dynamically.

Accordingly, a need exists for systems and methods for manipulating chemical or biological species which overcome one or more of the disadvantages of the conventional techniques.

### SUMMARY OF THE INVENTION

The invention provides systems and methods of manipulating biological or chemical species. The species may be attached to a magnetic particle which is manipulated using micro-magnetic fields. In some cases, the magnetic fields are generated by current carrying wires that are patterned on a substrate. The magnetic fields define channels on the surface of the substrate in which the magnetic particles and attached species may be transported, positioned, and stored amongst other operations. Thus, the systems and methods can manipulate biological or chemical species on a microscale. Applications of the systems and methods are in, but are not limited to, the fields of biotechnology, microanalysis, and microsynthesis.

In one aspect, the invention provides a method of manipulating a biological or a chemical species. The method includes manipulating a biological or a chemical species in a confined space having a maximum dimension of less than 5 cm using a magnetic field.

In another aspect, the invention provides a method of manipulating a biological or chemical species. The method includes manipulating a biological or a chemical species on a substrate in the absence of structural boundaries capable of confining the species.

In another aspect, the invention provides a method of manipulating a biological or a chemical species. The method includes manipulating a biological or a chemical species using a magnetic field generated by one or more current carrying wires.

In another aspect, the invention provides a method of manipulating a biological or a chemical species. The method includes moving a biological or chemical species in a first direction, and changing the direction of motion of the biological or chemical species using a magnetic field.

In another aspect, the invention provides a method of manipulating a biological or a chemical species. The method includes manipulating a biological or a chemical species on a substrate in the absence of fluid flow.

In another aspect, the invention provides a microfluidics system. The system includes a substrate including a plurality of wires capable of carrying current to generate magnetic fields that define channels on the substrate, and a biological or chemical species movable within the channels on the substrate.

Amongst other advantages, the systems and methods of the invention permits manipulation of chemical or biological species on a microscale (e.g., less than 5 cm). Microscale applications are particularly well-suited because the resulting high magnetic field gradients generates large net forces on the chemical or biological species (or magnetic particles attached thereto). Furthermore, such systems can manipulate species without the need for complex pumps and/or valves to control fluid flow. Also, substrates of the systems may be easily fabricated using conventional lithography techniques. The systems may also be easily re-configured, for example, by changing the current flow in wires patterned on the substrate to define different channels in which the species are manipulated. It is even possible to reconfigure the system during use (e.g., in real-time), for example, in response to measurements made by the system.

Other advantages, aspects, and features of the invention will become apparent from the following detailed description of the invention when considered in conjunction with the accompanying drawings. It should be understood that not every embodiment of the invention will include all of the advantages described herein.

### BRIEF DESCRIPTION OF THE DRAWINGS

FIG. 1 is a schematic plan view of a micromagnetic system that includes a microchip substrate according to one embodiment of the present invention.

FIG. 2 illustrates the resulting magnetic field at a selected height above parallel wires which carry current in opposite directions.

FIG. 3 illustrates the transport of magnetic particles through a channel defined by magnetic fields according to one embodiment of the present invention.

FIGS. 4A to 4D illustrate the movement of a magnetic particle by varying magnetic fields according to one embodiment of the present invention.

FIG. 5 illustrates a biological or chemical species attached to a magnetic particle according to one embodiment of the present invention.

FIGS. 6A-6D illustrate the steps of forming a microchip using the soft lithography process of the Example.

FIG. 7 schematically illustrates the micromagnetic system used in the Example.

FIGS. 8A to 8C show the confinement of magnetic beads in the Example using a magnetic field.

### DETAILED DESCRIPTION

The invention provides systems and methods for manipulating biological or chemical species. The species are manipulated on a microscopic scale using magnetic fields.

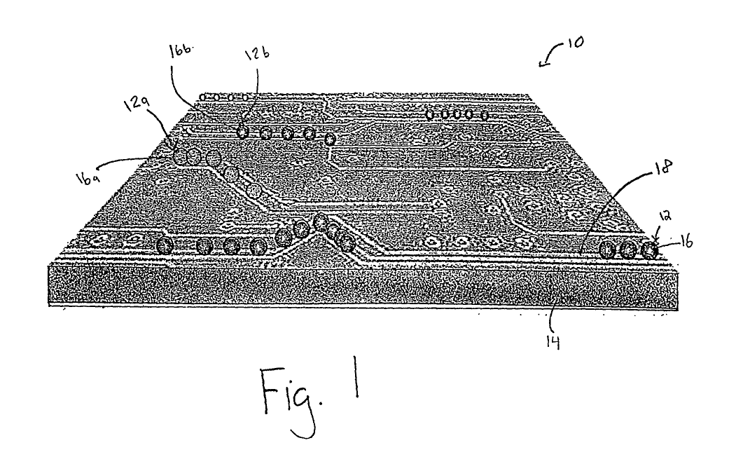

FIG. 1 shows a micromagnetic system 10 for manipulating chemical and biological species 12 on a substrate 14 according to one embodiment of the invention. Species 12 is attached to a magnetic particle 16. As shown, system 10 includes multiple particles 16 which, for example, are dispersed in a fluid medium disposed on the surface of substrate 14. System 10 generates localized magnetic fields by passing current through wires 18 formed on substrate 14. The magnetic fields are used to manipulate particles 16 and, consequently, species 12 attached thereto. Substrate 14 typically includes a pattern of multiple wires 18. Current flow through wires 18 is controlled to manipulate the species on system 10 as desired. The pattern of wires 18 enables multiple types of manipulation and allows for simple reconfiguration of the system as described further below.

Species 12 are manipulated using the principle that particles 16 are attracted to magnetic fields and, particularly, to locations where relatively strong magnetic fields compared to immediate surrounding regions (i.e., local magnetic field maxima) are present. Current passing through a wire, or an arrangement of wires, can generate a magnetic field. The magnitude and location of the magnetic field generated depends, in part, upon system design parameters (e.g., the wire arrangement) and system operating parameters (e.g., the amount of current). Another way to generate a magnetic field is using an externally applied magnetic field. In some embodiments, both magnetic fields generated by current carrying wires and externally magnetic fields may be used. System 10 is designed and operated in a manner that generates localized magnetic fields in specific locations which attract and manipulate particles 16, as described further below.

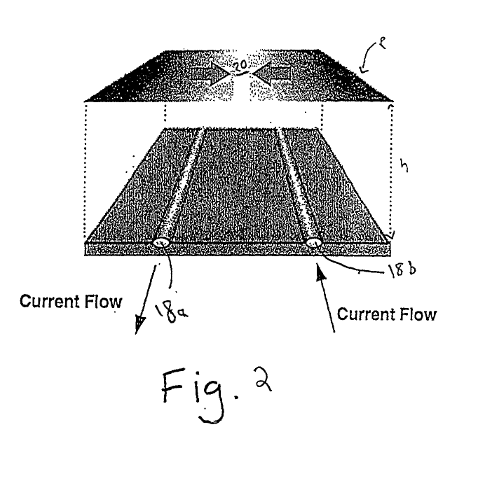

FIG. 2 schematically illustrates one portion of substrate 14 which includes parallel wires 18a, 18b that may be utilized on substrate 14 to generate a magnetic field according to one embodiment of the invention. When parallel wires 18a, 18b carry current in the opposite direction (as indicated by arrows), a magnetic field is generated above substrate 14. The magnetic field has a magnitude in plane (p) that is proportional to the degree of shading (i.e., regions of strong magnetic field are lightly-shaded and regions of weak magnetic field are darkly-shaded). In this illustrative arrangement, the strongest magnetic field in plane (p) is located in a region 20 equidistant between current carrying wires 18a, 18b. It should also be understood that system 10 may include other arrangements of wires to generate magnetic fields including single wires and wires with one or more turns.

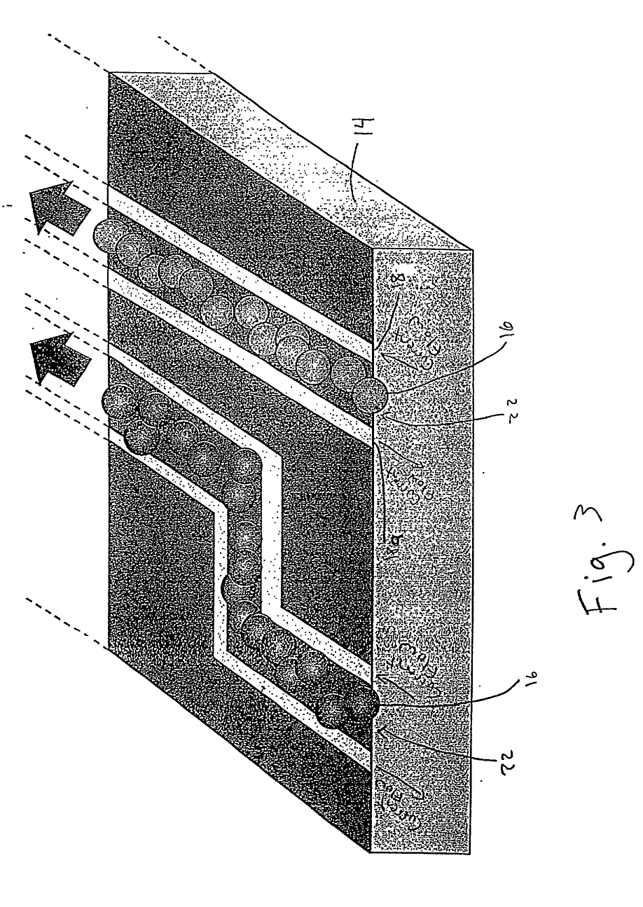

Referring to FIG. 3, substrate 14 includes an arrangement of parallel current carrying wires 18a, 18b similar to the arrangement shown in FIG. 2. The magnetic field generated by current carrying wires 18a, 18b attracts magnetic particles 16 and confines the particles to a region between the wires 18a, 18b where a local magnetic field maxima is present. Such regions of strong magnetic field, therefore, define a channel 22 that extends between parallel wires 18a, 18b.

Channels 22 may have a variety of different dimensions as required for a particular application of system 10. Typical channel widths are less than about 500 microns. In other cases, shorter channel widths are desired such as widths of less than about 100 microns or less than about 50 microns. Shorter channel widths may be desired, for example, when the pattern includes a large number of channels. Generally, channel lengths are less than about 5 cm. More typically, even shorter channel lengths are utilized such as less than about 5 mm, or even less than about 0.5 mm. In some embodiments, system 10 may include a number of channels 22 which have different lengths and/or widths. Channels 22 may have different shapes which include tapered channels and or channels with enlarged regions. In some cases, channel 22 include a closed end that defines, for example, an enlarged region that may have a width greater than that of the channel. Such enlarged regions may be for storage of the species.

Wires 18 may be formed on substrate 14 in any variety of patterns and the particular pattern may be designed for the desired application. In one set of embodiments, wires are formed in a grid pattern. Current flow through the pattern of wires 18 is controlled so as to selectively form channels 22 in specific locations when desired. In many cases, multiple channels 22 may be formed at the same time by simultaneously passing current through different wires (or wire arrangements) on substrate 14. However, it should be understood that current may not flow through all wires 18 patterned on substrate 14 at all times. Because channel formation is controlled by current flow, substrate 14 may be easily re-configured to provide different channels by changing which wires 18 in the pattern carry current.

The confinement of particles 16, and species 12 attached thereto, within channels 22 is one type of manipulation provided by the present invention. In some cases, particles 16 are further manipulated once confined within channels 22. For example, particles 16 may be transported within channels 22. If particles 16 are suspended in a fluid medium, the particles may be transported within channel 22 via attraction by another magnetic field (i.e., a field that is different than the field that formed the channel). The magnetic field which attracts the particles within the channel may be generated by a current carrying wire positioned nearby or an external magnetic field. When a current carrying wire is used to generate the field that attracts the particles, the current may be pulsed so as to limit heating. In other cases, as described further below, particles 16 may be transported by varying the location of the local field maxima within channel 22.

Wires 18 may be patterned in a manner that forms channels 22 which can transport particles 16 to a desired location (e.g., a storage region). Once transported to the desired location, species 12 attached to particles 16 may be stored, detected, caused to react with another species, or otherwise further manipulated. Channels 22 advantageously permit transportation of species 12 without structural boundaries, such as physical channels which are formed in the substrate, as in certain conventional microfluidic systems. In some cases, channels 22 are used in conjunction with physical channels to enhance performance.

In certain embodiments, particles 16 may be transported within channel 22 by varying the position of the local field maxima. As described above, particles 16 are attracted to a position where strong magnetic fields are present. Thus, by appropriate changing the position of the strongest magnetic field, particle 16 may be moved.

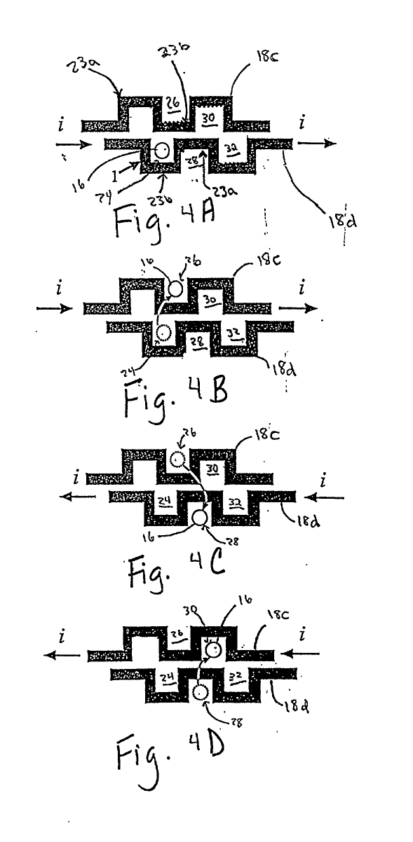

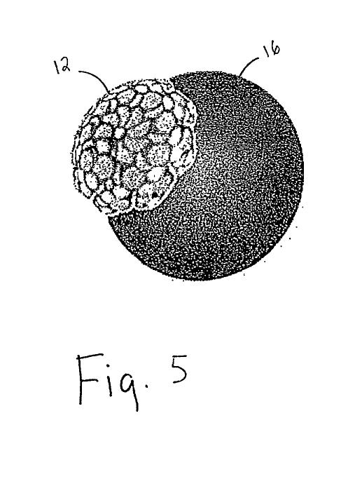

FIGS. 4A to 4D schematically illustrate transporting particle 16 by moving the position of the local field maxima generated by current flowing through wires 18c, 18d in combination with an applied bias field. Wires 18c, 18d have a series of turns including an alternating arrangement of n-shaped turns 23a and unshaped turns 23b. Depending on the direction of current flow and the direction of the applied bias field, the location of the local field maxima is in a position (e.g., 24, 26, 32) within unshaped turns 23b, or a position (e.g., 28, 30) within n-shaped turns 23a. By selectively varying which of wire 18c, 18d carries current and the direction of the current, the position of the local field maxima and particle 16 may be moved.

In FIG. 4A, particle 16 is confined to a position 24 within unshaped turn 23b, where the local field maxima is generated from current flowing downstream (shown by arrow) through wire 18d. In FIGS. 4A to 4D, a bias field is applied in a perpendicular direction coming out of the page. To transport particle 16, current flow through wire 18d is stopped and downstream current flow through wire 1 8c is started. The local field maxima is now generated at a position 26 within unshaped turn 23b causing particle 16 to move from position 24 to position 26 (FIG. 4B). To continue the transportation of particle 16, current flow through wire 1 8c is stopped and upstream (shown by arrow) current flow through wire 1 8d is started. The local field maxima is now generated at a position 28 causing particle 16 to move from position 26 to position 28. To continue the transportation of particle 16, the current flow through wire 18c is stopped and upstream current flow through wire 1 8d is started. The local field maxima is now generated at a position 30 causing particle 16 to move from position 28 to position 30 (FIG. 4D). In this manner, particle 16 (or a plurality of particles) may be transported by moving the location of the local field maxima.

In the methods of the invention, the magnetic field generated by current carrying wires 18 should have a maximum value sufficient to attract particles 16. In some embodiments, the strongest field generated by current carrying wires 18 is less than about 2 kG (e.g., on the order of about 1 kG). Different applications may require different field strengths. The magnetic fields generated by current carrying wires 18 generally act over a short range. For example, the fields may be localized to act over a range of less than about 100 microns. The localization permits confinement of particles 16 within small dimensions which enables a number of processes to occur in parallel on the same substrate. The magnetic fields may also be easily adjusted, controlled, or reconfigured, by changing the amount of current flow, the direction of current flow, or which wires carry current. System 10, thus, is very flexible and can be easily tailored for different applications.

In one embodiment, wires 18 have a width between about 50 microns and about 100 microns and a height between about 10 microns and about 20 microns. Wires 18 having such dimensions are generally capable of carrying direct current of at least about 10 A at room temperature which can generate maximum magnetic fields on the order of about 1 kG. It should be understood that wires 18 may also have other dimensions if desired for a particular application.

Wires 18 may be fabricated using known lithography techniques on the surface of the substrate 14 including soft lithography techniques. Suitable lithography techniques typically include deposition, patterning, and etching steps to form wires having the desired arrangement. An exemplary lithography technique has been described in Xia YN. Whitesides GM. SOFT LITHOGRAPHY. [Review]. Angewandte Chemie (International Edition in English). 37(5):551-575, 1998 March 16., which is incorporated herein by reference.

In some embodiments, an external magnetic field (i.e., a bias field) may be superimposed on the field generated by the current carrying wires. Superimposed external fields may be used, for example, to change patterns of local magnetic field maxima by constructively and/or destructively interfering with the field generated by the current carrying wires. The external magnetic field can be generated by an external magnet positioned proximate to substrate 14.

In some embodiments, system 10 optionally includes a magnetic material layer 31 (FIG. 1) formed on substrate 14. Magnetic material layer 31, for example, may be formed between wires 16 and substrate 14 (i.e., wires 16 are formed on magnetic material layer) or on top of wires 16. It should be understood that, in other embodiments, system 10 may not include a magnetic material layer 31. Magnetic material layer 31 comprises a magnetic material in which a magnetic field may be induced semi-permanently. That is, a field induced in the material is retained in the material (even when the inducing field is removed), and the induced field can be erased by an another applied field. Examples of such magnetic materials include compounds (e.g., oxides) of cobalt, iron, and chrome.

When magnetic material layer 31 is used, fields generated by current carrying wires 16 include local magnetic field maxima within magnetic material layer 31. The local magnetic field maxima generated by the magnetic material layer defines, in part, channels 22 in conjunction with the local magnetic field maxima generated by the current carrying wires. Even when current flow through wires 16 is stopped, the local field maxima continue to be generated by magnetic material layer 31 and continue to define channels 22. Thus, channels 22 can be formed by applying the current for a short time (i.e., pulsing the current) to induce local field maxima in magnetic material layer 31. The pulsing of the current may advantageously reduce heating effects associated with current flowing through wires for long time periods. Thus, utilization of magnetic material layer 31 may be preferred in some systems that are particularly susceptible to damage from over heating. The induced local field maxima in magnetic material layer 31 may be removed by applying an external field of sufficient strength and opposite direction, for example, in order to re-configure channels 22 within system 10.

Species 12 can be any biological or chemical species. Typical examples include chemical reagents, cellular material, nucleic acids, proteins, polypeptides, lipids, carbohydrates, and polymers including synthetic polymers. In some applications, more than one type of species 12 may be manipulated at the same time using micromagnetic system 10. Different types of species 12 may be attached to different particles. As shown in FIG. 1, system 10 may be used to manipulate, in parallel operations, a first species 12a attached to a particle 16a and a second species 12b attached to a particle 16b. However, it should be understood that it is also possible for an individual particle 16 to have more than one type of species attached thereto. Magnetic particle 16 may have any composition that enables it to be manipulated by a magnetic field. The composition typically includes at least one magnetic component and also may include one or more non-magnetic components. In some embodiments, magnetic particle 16 may comprise a superparamagnetic material (i.e., materials that lose their magnetization in the absence of a magnetic field) which may allow for recycling of particles. In some cases, particle 16 has a non-magnetic coating around a magnetic core. The coating may have a chemical structure that permits attachment of species 12 thereto. Species 12, for example, can be chemically bonded to the coating thereby attaching the species to the particle. Suitable coatings include polymeric materials, such as polystyrene. The particular coating composition can depend upon the type of species 12 being attached.

Particles 16 may have a variety of shapes and sizes depending on the application. In some embodiments, a substantially spherical particle (i.e., a bead) may be preferred. In most microscale applications, the size of particles 16 are less than 100 microns. However, larger size particles may also be used if desired. In some embodiments, the particle size is less than about 10 microns; in others, the particle size is less than about 1 micron; in others less than about 100 nanometers. In some embodiments the particle size is between about 1 micron and about 10 microns. Smaller particle sizes may be desired, for example, in systems that have small channel widths.

System 10 may utilize one type of particle 16 (i.e., same composition and dimensions), or may utilize more than one type of particle. Different types of particles may be used in system 10, for example, if more than one type of species 12 is being manipulated. However, it should also be understood that one type of particle may be used with different species.

In some embodiments, it is desirable for species 12 to be selectively attached to particle 16. That is, species 12 can be attached to particle 16 under certain conditions and can be released from particle 16 under other conditions. For example, species 12 may be attached to particle 16 at the start of an operation and then transported to another position on substrate and released from the particle. Species 12 may be attached to particle 16 through chemical bonding via a reaction between the species and a component of the particle (e.g., a coating on particle 16) and released by removing the bond, for example, using a solvent. The solvent may be introduced into system 10 at a desired location to release the species. Once released, species 12 may react with other species or be analyzed, amongst other operations.

In some preferred cases, particles 16 are dispersed in a fluid (not shown) disposed on the surface of substrate 14. Suitable fluids include water and non-aqueous fluids, as well as mixtures and solutions thereof. Additives may be added to the fluid to promote dispersion or for other reasons. The fluid can provide a low friction medium in which particles 16 may be manipulated. In these embodiments, particles 16 may be manipulated irrespective of fluid flow. In some cases, no fluid flow occurs on substrate 14. In certain cases, however, fluid flow may be used to enhance particle manipulation. It should also be understood that particles 16 may not be dispersed in a fluid in certain embodiments.

Substrate 14 may be any suitable substrate. For example, substrate 14 may be any type used in integrated circuit applications such as a microchip. Suitable substrate materials include semiconductor (e.g., silicon) materials and polymeric materials. Substrate 14 may have a number of layers formed thereupon including oxide layers, metallic layers (which may be magnetic layers), and the like. The dimensions of substrate 14 may be determined, in part, by the application. In some cases, the surface area of substrate is less than about 10 cm²; in others less than about 1 cm²; and in others less than about 1 mm². The maximum dimension (e.g., length or width) of substrate 14 may be less than about 5 cm, in other cases less than 5 mm; and, in other cases, less than 1 mm.

Particles 16 are manipulated in the systems and methods of the invention in any number of different ways. For example, the magnetic fields may be used to manipulate particles 16 by directing, transporting, storing, positioning, trapping, confining, separating, and mixing, amongst other types of manipulation. In exemplary cases, biological or chemical species 12 are transferred between storage microcells, reaction microcells, or detection microcells. The particular manner in which magnetic particles 16 are manipulated depends upon the application of system 10. Manipulation system 10 may be used in any number of applications. Because system 10 uses magnetic fields on a microscopic level, large numbers of manipulations may be provided on a single substrate 14. Thus, a large number of different operations may occur in parallel on system 10. Also, because system 10 involves manipulating species on the microscopic scale, operations can occur within short time periods.

It should be understood that the systems and methods of the invention may have a variety of variations. For example, the micromagnetic fields may be generated using techniques other than current carrying wires. Other variations will be known to one of ordinary skill in the art.

The function and advantage of these and other embodiments of the present invention will be more fully understood from the example below. The following example is intended to illustrate the benefits of the present invention, but do not exemplify the full scope of the invention.

### EXAMPLE

### Micromagnetic System and Method

This example illustrates the ability of a micromagnetic system to manipulate magnetic particles.

The micromagnetic system included a microchip substrate which was produced using a soft lithography process. FIGS. 6A-6D schematically illustrate the steps of the soft lithography process to form a microchip 33. FIG. 6A shows a CAD design 34 of the microchip. FIG. 6B shows micromolds 36 produced in a rapid prototyping step from CAD design 34. Micromolds 36 were made of polydimethylsiloxane (PDMS). Micromolds 36 were used to form a pattern 37 in a polyurethane layer 38 on a silicon substrate 40 using a microtransfer molding technique (FIG. 6C). Silicon substrate 40 also included a silicon oxide layer 42 and a silver layer 44 formed in succession beneath polyurethane layer 38. Pattern 37 was filled with gold using an electroplating technique. Polyurethane layer 38 was etched using a solution of CH₂Cl₂: CH₃OH: NH₄OH, (100:25:3). Then, a wet chemical etching process was used to remove silver layer 44 using an aqueous solution of 0.1 M Na₂S₂O₃/0.01M K₃ Fe(CN)₆/0.001M K₄Fe(CN)₆. After the etching steps, gold wires 46 were formed on the surface of chip 33. The height of wires 18 was controlled during the electroplating process. Wires 46 had uniform dimensions verified by measurements of a profilometer.

FIG. 7 schematically illustrates a system 48 used to manipulate microbeads 50 using magnetic fields generated by current flowing through wires 46 on chip 33. Microbeads 50 were composed of a magnetite core surrounded by a polystyrene shell (Dynal M-450, manufactured by Dynal, Inc.; Lake Success, N.Y.) and had a diameter of about 4.5 microns. Microbeads 50 were dispersed in a water solution to provide a mixture. The mixture of microbeads 50 and water was confined in a container 52 disposed on a sample holder 54 below chip 33. The distance between the surface of the mixture and chip 33 was between about 100 microns and 500 microns. Though the experiment did not include magnetic beads dispersed on the surface of the integrated chip, it is to be understood that this configuration could also be performed. A permanent magnet 56 was positioned above chip 33 to provide an external magnetic field. System 48 included a lens 58 and CCD camera 60 to record images of microbeads 50.

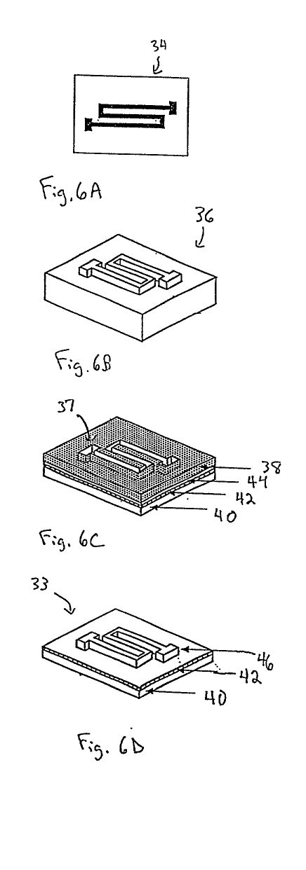

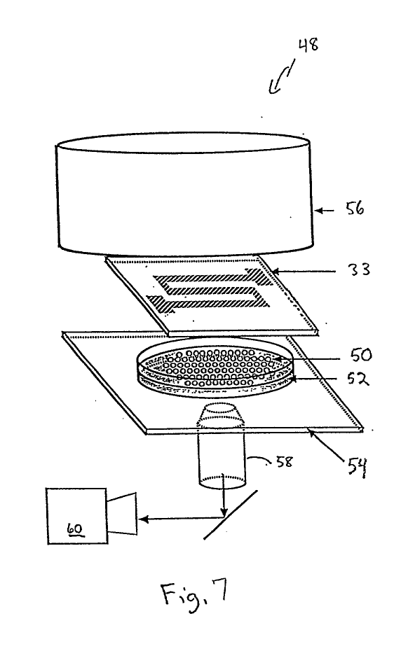

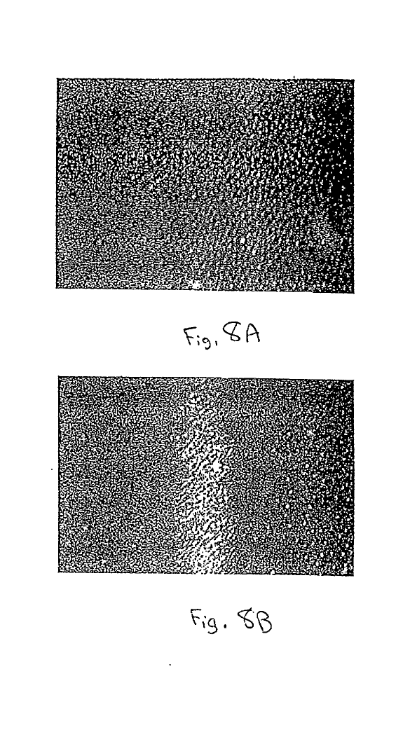

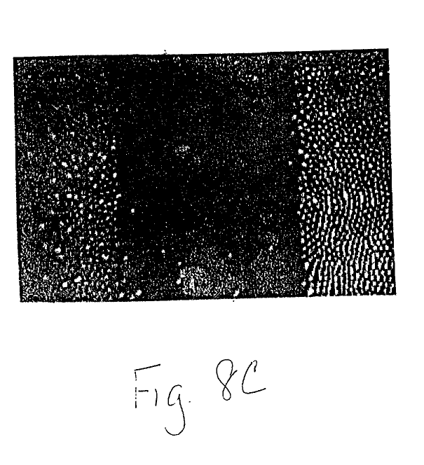

FIG. 8A is a micrograph showing microbeads 50 prior to the generation of a magnetic field. In FIG. 9A, microbeads 50 are dispersed uniformly throughout the mixture.

A current of about 1 A was passed through wires 46 in a first direction to generate a magnetic field. An external magnetic field was superimposed on the field generated by the current carrying wires using permanent magnet 56. FIG. 8B is a micrograph showing the confinement of microbeads 50 in a channel using the magnetic fields.

A current of about 1 A was passed through wires 46 in a second direction opposite to the first direction (as described above in connection with FIG. 8B) to generate a magnetic field. An external magnetic field was superimposed on the field generated by the current carrying wires using permanent magnet 56. The external magnetic field was in the same direction as described above in connection with FIG. 8B. FIG. 8C is a micrograph showing the expulsion of microbeads from a channel using magnetic fields.

The example shows how a micromagnetic system may be used to manipulate magnetic particles. Specifically, the system was used to selectively confine and expel magnetic microbeads within a channel.

Those skilled in the art would readily appreciate that all parameters listed herein are meant to be exemplary and that the actual parameters would depend upon the specific application for which the systems and methods of the present invention are used. It is, therefore, to be understood that the foregoing embodiments are presented by way of example only and that, within the scope of the appended claims and equivalence thereto, the invention may be practiced otherwise than as specifically described.

What is claimed:

1. A method of manipulating a biological or a chemical species comprising:
manipulating a biological or a chemical species in a confined space having a maximum dimension of less than 5 cm using a magnetic field.

2. The method of claim 1, wherein the species is attached to a particle comprising a magnetic material.

3. The method of claim 2, wherein the particle includes a coating and a magnetic material core.

4. The method of claim 3, wherein the particle has a size of less than 100 microns.

5. The method of claim 1, wherein the magnetic field is generated by one or more current carrying wires.

6. The method of claim 5, wherein the wires are disposed on a substrate.

7. The method of claim 1, wherein the magnetic field is generated by a magnetizable layer.

8. The method of claim 7, wherein the magnetic field generated by the magnetizable layer is induced in the magnetizable material.

9. The method of claim 1, wherein the confined space is defined on a substrate.

10. The method of claim 9, wherein the confined space comprises a channel defined by local field maxima generated by current flowing through wires formed on the substrate.

11. The method of claim 1, wherein the confined space has a maximum dimension of less than 1 mm.

12. The method of claim 1, wherein the species is suspended in a fluid.

13. The method of claim 1, comprising manipulating the species without fluid flow.

14. The method of claim 1, wherein manipulating the species comprises directing the motion of the species.

15. The method of claim 1, further comprising moving the biological or chemical species by attracting the species with a magnetic field.

16. The method of claim 1, comprising varying the position of the magnetic field by changing the position of local field maxima.

17. The method of claim 1, wherein manipulating the biological or chemical species comprises capturing and confining the biological or chemical species.

18. The method of claim 1, comprising manipulating a first biological or chemical species in a confined space having a maximum dimension of less than 5 cm using a magnetic field to bring the first species in contact with a second biological or chemical species thereby causing a reaction between the first and second species.

19. The method of claim 1, comprising separating a first biological or chemical species from a second biological or chemical species in a confined space having a maximum dimension of less than 5 cm using a magnetic field.

20. A method of manipulating a biological or chemical species comprising:
manipulating a biological or a chemical species on a substrate in the absence of structural boundaries capable of confining the species.

21. The method of claim 20, comprising selectively manipulating the species using a magnetic field.

22. The method of claim 21, wherein the magnetic field is generated by one or more current carrying wire disposed on a substrate.

23. The method of claim 20, wherein the species is attached to a particle comprising a magnetic material.

24. The method of claim 20, wherein the particle has a size of less than 100 microns.

25. The method of claim 21, wherein the magnetic field defines, at least in part, a channel in which the species may move.

26. The method of claim 25, wherein the channel has a maximum dimension of 5 cm.

27. The method of claim 20, wherein the species is suspended in a fluid.

28. The method of claim 20, comprising manipulating the species without fluid flow.

29. The method of claim 20, wherein manipulating the species comprises directing the motion of the species.

30. The method of claim 20, further comprising moving the biological or chemical species.

31. The method of claim 30, comprising moving the biological or chemical species by varying the position of the magnetic field.

32. A method of manipulating a biological or chemical species comprising:
manipulating a biological or a chemical species using a magnetic field generated by one or more current carrying wires.

33. The method of claim 32, wherein the wires are disposed on a substrate.

34. The method of claim 32, wherein the magnetic field defines, at least in part, a channel in which the species may move.

35. The method of claim 34, wherein the channel has a maximum dimension of 5 cm.

36. The method of claim 34, wherein the channel has a maximum dimension of 1 mm.

37. The method of claim 32, wherein the species is attached to a particle comprising a magnetic material.

38. The method of claim 32, wherein manipulating the species comprises directing the motion of the species.

39. The method of claim 32, further comprising moving the biological or chemical species.

40. The method of claim 32, comprising moving the biological or chemical species by varying the position of the magnetic field.

41. A method of manipulating a biological or chemical species comprising:
moving a biological or chemical species in a first direction; and
changing the direction of motion of the biological or chemical species using a magnetic field.

42. The method of claim 41, wherein the magnetic field defines, at least in part, a boundary.

43. The method of claim 41, comprising moving the species in the first direction a distance of less than 5 cm prior to changing the direction of motion.

44. A method of manipulating a biological or chemical species comprising:
manipulating a biological or a chemical species on a substrate in the absence of fluid flow.

45. A microfluidics system comprising:
a substrate including a plurality of wires capable of carrying current to generate magnetic fields that define channels on the substrate; and
a biological or chemical species movable within the channels on the substrate.

46. The microfluidics system of claim 45, wherein the species is attached to a particle comprising magnetic material.

47. The microfluidics system of claim 46, wherein the particle includes a coating and a magnetic material core.

48. The microfluidics system of claim 45, wherein the particle has a size of less than 100 microns.

49. The microfluidics system of claim 45, wherein the substrate has a maximum dimension of less than 5 cm.

50. The microfluidics system of claim 45, wherein the substrate has a maximum dimension of less than 1 mm.

51. The microfluidics system of claim 45, further comprising a fluid disposed on the substrate, the species being flowable through the fluid.

52. The microfluidics system of claim 45, further comprising a voltage source connectable to the plurality of wires.

53. The microfluidics system of claim 45, further comprising an external magnet.

54. The microfluidics system of claim 45, further comprising a magnetizable material layer disposed on the substrate.
